(19) United States
(12) Patent Application Publication
(10) Pub. No.: US 2002/0112109 A1
(43) Pub. Date: Aug. 15, 2002

(54) Method and apparatus for providing full duplex/half duplex radially distributed serial control bus architecture

(76) Inventor: Anthony William Jorgenson, Fremont, CA (US)

Correspondence Address: Seong-Kun Oh, Sierra Patent Group, P.O. Box 6149, Stateline, NV, 89449, US

(21) Appl. No.: 09/828,481

(22) Filed: Apr. 6, 2001

Related U.S. Application Data
(60) Provisional application No. 60/269,223, filed on Feb. 14, 2001.

(51) Int. Cl. G06F 13/00

(52) U.S. Cl. 710/305

(57) ABSTRACT

A communication network includes peripheral cards in the backplane that are individually connected using separate interface cables to the system controller for individual isolation to provide full duplex/half duplex radially distributed serial control bus architecture with high level data link control (HDLC) bus interface which provides for collision detection, fault isolation and peripheral card communication fault recovery.

### BACKGROUND OF THE INVENTION

1. Field of the Invention

The present invention relates to control bus for embedded equipment.

More particularly, the present invention relates to method and apparatus for providing a full duplex/half duplex radially distributed high level data link control (HDLC) bus with fault isolation capabilities.

2. Description of the Related Art

High-level data link control (HDLC) is a common protocol in the data link layer, layer 2 of the OSI model. Other common layer 2 protocols such as SDLC, SS#7, Appletalk, LAPB and LAPD, are based on HDLC and its framing structure. FIG. 1 illustrates a typical HDLC framing structure. HDLC uses a zero insertion/deletion process, referred to as bit-stuffing, to ensure that a data bit pattern matching the delimiter flag does not occur in a field between flags. Generally, the HDLC frame is synchronous, and relies on the physical layer for clocking and synchronization of the transmitter/receiver.

Referring to FIG. 1, a 16-bit address field 102 is provided to carry the frame's destination address as the layer 2 frame can be sent over point-to-point links, broadcast networks, packet-switched or circuit switched systems and so on. While shown in FIG. 1 as a 16-bit field, the address field 102 can be 0, 8, or 16 bits, depending on the data link layer protocol. For example, SDLC and LAPB use an 8-bit address, while SS#7 has no address field since it is always used in point-to-point signaling links. On the other hand, LAPD divides its 16-bit address into different fields to specify various access points within one device. Additionally, some HDLC-type protocols permit addressing beyond 16 bits.

Further shown in the HDLC framing structure of FIG. 1 is a control field 103. While illustrated as an 8-bit control field, it can be an 8- or a 16-bit control field, and provides a flow control number and defines the frame type whether control or data. The particular use and structure of the control field 103 depends upon the protocol using the frame. Moreover, shown as 8n-bit information field 104, the length of the data in the information field 104 depends on the frame protocol. Also, layer 3 frames are carried in the data field 104. A cyclic redundancy check (CRC) field 105 is appended to the frame to implement error control may be 16 bits long but can be as long as 32 bits. For example, in HDLC, the least significant bit (LSB) of each octet is sent first, while the most significant bit (MSB) of the CRC is sent first.

In general, a Serial Communications Controller (SCC) can be connected through the time division multiplexing (TDM) channels of the serial interface (SI). In HDLC mode, an SCC becomes an HDLC controller, and consists of separate transmit and receive sections whose operations are asynchronous with the core and can either be synchronous or asynchronous with respect to other SCCs. The HDLC controller includes an option for hardware collision detection and retransmission on an open-drain connected HDLC bus, referred to as HDLC bus mode. Most HDLC-based controllers provide only point-to-point communications. However, the HDLC bus enhancement allows implementation of an HDLC-based local area network (LAN) and other point-to-multipoint configurations. The HDLC bus is based on techniques used in the CCITT ISDN 1.430 and ANSI T1.605 standards for D-channel point-to-multipoint operations over the S/T interface. However, the HDLC bus does not fully comply with the I.430 or T1.605, and cannot replace devices that implement these protocols. Instead, it is more suited to non-ISDN LAN and point-to-multipoint configurations.

The I.430 and T1.605 standards define a manner in which to connect eight terminals over the D-channel of the S/T ISDN bus. In particular, these standards provide a physical layer protocol that allows multiple terminals to share one physical connection. These protocols handle collisions efficiently because one station can always complete its transmission, at which point, it lowers its own priority to give other devices fair access to the physical connection. To determine whether a channel is clear, the S/T interface device looks at an echo bit of the line designed to echo the last bit sent on the D channel. Depending on the class of the terminal and the context, an S/T interface device waits for 7-10 ones on the echo bit before letting the LAPD frame begin transmission, after which, the S/T transmission continues. If the echo bit is ever a 0 when the transmit bit is a 1, a collision occurs between terminals, and the station(s) that sent a zero stops transmitting while the station that sent a 1 continues as normal.

As a matter of comparison, the HDLC bus differs from the I.430 and T1.605 standards in several ways. First, the HDLC bus uses a separate input signal rather than the echo bit for monitoring. Moreover, the HDLC bus is a synchronous, digital open-drain connection for short-distance configurations, rather than the more complex S/T interface. Additionally, the collision-detection mechanism only supports NRZ-encoded data, a common synchronous clock for all receivers and transmitters, non-inverted data, and open-drain connection with no external transceivers.

FIG. 2 illustrates a typical HDLC multimaster LAN configuration while FIG. 3 illustrates a typical HDLC bus single-master configuration. Referring to FIG. 2, a station can transfer data to or from any other LAN station, and transmissions are half-duplex, which is typical in LANs. Furthermore, transceivers may be used to extend the LAN size. As configured, the TXD pins of slave devices are configured to open-drain in the port C parallel I/O port, and the clock is a common RCLK/TCLK for all stations. Referring to FIG. 3 transceivers may be used to extend the LAN size, and similar to the multi-master configuration, the TXD pins of slave devices are configured to open-drain in the port C parallel I/O port. Moreover, as shown, Clock1 may be provided as master clock RCLK and slave clock TCLK, while Clock2 may be provided as master clock TCLK and slave clock RCLK. In the single-master configuration shown in FIG. 3, a master station transmits to any slave station without collisions. Slaves communicate only with the master, but can experience collisions in their access over the bus. In this configuration, a slave that communicates with another slave must first transmit its data to the master, where the data is buffered in a random access memory (RAM) and then resent to the other slave. In this configuration, full-duplex operation may be obtained and may support a point-to-multipoint environment.

In general, the HDLC bus protocol ensures orderly bus control when multiple transmitters attempt simultaneous access. The transmitter sending a zero bit at the time of collision completes the transmission. If a station sends out an opening flag (0x7E) while another station is already sending, the collision is always detected within the first byte, because the transmission in progress is using zero bit insertion to prevent flag imitation.

While in the active condition (ready to transmit), the HDLC bus controller monitors the bus using Clear to Send (CTS (INSERT OVERSCORE)). It counts the one bits on CTS (INSERT). When eight consecutive “1”s are counted, the HDLC bus controller starts transmitting on the line; if a “0” is detected, the internal counter is cleared. During transmission, data is continuously compared with the external bus using CTS (INSERT). CTS (INSERT) is sampled halfway through the bit time using the rising edge of the Tx clock. If the transmitted bit matches the received CTS (INSERT) bus sample, transmission continues. However, if the received CTS (INSERT) sample is “0” and the transmitted bit is “1”, transmission stops after that bit and waits for an idle line before attempting retransmission.

Since the HDLC bus uses a wired-OR scheme, a transmitted “0” has priority over a transmitted “1”. FIG. 4 illustrates a timing chart for detecting an HDLC bus collision. As shown, if both the destination address and the source address are included in the HDLC frame, then a predefined priority of stations results. On the other hand, if two stations begin to transmit simultaneously, they detect a collision no later than the end of the source address.

The HDLC bus priority mechanism ensures that stations or peripheral cards share the bus equally. To minimize idle time between messages, a station normally waits for eight one bits on the line before attempting transmission. After successfully sending a frame, a station waits for 10 rather than eight consecutive one bits before attempting another transmission. This mechanism ensures that another station waiting to transmit acquires the bus before a station can transmit twice. When a low priority station detects 10 consecutive ones, it tries to transmit, and if it fails, it reinstates the high priority of waiting for only eight ones.

Given that the peripheral cards share the HDLC bus, a single peripheral card failure in the HDLC bus mechanism can short out the bus preventing all serial control bus communications. In other words, in the conventional HDLC bus architecture, since transmit and collision connections to all peripheral cards are connected together, when a single peripheral card fails, it is difficult to readily determine and isolate which peripheral card is faulty without physically accessing the peripheral cards for servicing.

Isolation of individual peripheral card failures may be achieved by utilizing a separate communications controller for communications with each peripheral card. However, this approach would significantly increase the amount of board space necessary for implementation. While a multiplexing communications controller may be deployed to use less board space, the communications and CPU bandwidth required to support this configuration would be significantly higher.

Therefore, it would be desirable to have a control bus for embedded systems that support full duplex/half duplex data communications with fault isolation capabilities.

### SUMMARY OF THE INVENTION

In view of the foregoing, in one embodiment, the serial control bus (SCB) is distributed across radial leads from the system controller to each peripheral card. At the system controller, the receive signals from each peripheral card are passed to a device that allows them to be individually disabled before being “bussed” via an AND gate on the system controller. To isolate bus faults (i.e., a shorted bus), the system controller may disable each signal one at a time, to identify the peripheral card or cards that are affecting the SCB communications. In this manner, in one embodiment, the present invention provides system and method for radially distributed point to point architecture with fault isolation.

A radially distributed serial control bus architecture, in accordance with one embodiment of the present invention includes a controller, a plurality of connections, each connection having a first end and a second end, each of said first end of said each connection coupled to said controller, and a plurality of peripheral cards each peripheral card individually coupled to a respective second end of a dedicated one of said plurality of connections.

A method of providing a radially distributed serial control bus architecture in accordance with another embodiment of the present includes the steps of connecting each of a first end of a plurality of connections to a controller, and individually connecting each of a plurality of peripheral cards to a respective second end of a dedicated one of said plurality of connections.

In one embodiment of the present invention, each peripheral card includes a transmit connection and a collision connection, where each of the transmit and collision connections for each of peripheral card are separately connected to a separate second end of the respective dedicated connection. Moreover, in a further embodiment of the present invention, the transmit and collision connections for each peripheral card may be a transmit lead or pin and a collision lead or pin on each peripheral card which are individually separately connected to the system controller.

In yet another embodiment of the present invention, the serial control bus architecture may further include a logic device provided between each of said peripheral cards and said controller, where said logic device includes a field programmable gate array device. Moreover, in another embodiment of the present invention, the logic device may include a plurality of drivers each dedicated to receive signals from a particular one of said plurality of peripheral cards, where said controller is configured to individually disable one or more of said plurality of drivers.

The logic device of the serial control bus architecture in accordance with yet another embodiment of the present invention may include a control unit for generating a control signal; a plurality of OR gates each configured to perform an OR operation to said control signal and a signal received from a respective peripheral card; and an AND gate configured to perform an AND operation to outputs of said OR gates, and to provide an output AND signal to said controller.

Additionally, in accordance with a further embodiment of the present invention, each of the plurality of connections may be a hard wire connection having a length ranging from one inch to seven feet. Furthermore, the controller may be one of a MPC 860 processor, a MPC 850 processor, and a MPC 8260 processor.

In this manner, in accordance with the present invention, the serial control bus may be configured to operate at a frequency of approximately 3 MHz with a balanced duty cycle clock to as much as 6 MHz with an unbalanced 1-to-8 duty cycle clock in half duplex or full duplex mode. Moreover, in accordance with the present invention, each of said plurality of peripheral cards may be coupled to an optical data communications network, each configured to receive and transmit electrical and optical signals, wherein said optical signals include one of OC-3, OC-12 and OC-48, and said electrical signals include one of STS-3, STS-12 and STS-48.

Accordingly, in accordance with the present invention, the serial control bus interface uses the HDLC bus mode which provides Carrier Sense Multiple Access with Collision detection (CSMA-CD) with a fair access scheme allowing all of the 6 Mbps bandwidth to be efficiently utilized. The HDLC bus handles collisions by allowing only one colliding frame to continue transmitting while all others are stopped. The collision detection is made within one bit time allowing the winning frame to complete transmission without error. Since this mechanism requires no back-off and retry such as may be the case with Ethernet connection, all of the bus bandwidth is available for data except for the frame overhead. The fairness algorithm makes a transmitting station, that has already transmitted once, wait two extra bit times after the end of a transmission in progress before beginning a new transmission. This mechanism allows all colliding stations to transmit once before any of them can transmit again.

These and other features and advantages of the present invention will be understood upon consideration of the following detailed description of the invention and the accompanying drawings.

### BRIEF DESCRIPTION OF THE DRAWINGS

FIG. 1 illustrates a typical HDLC framing structure.

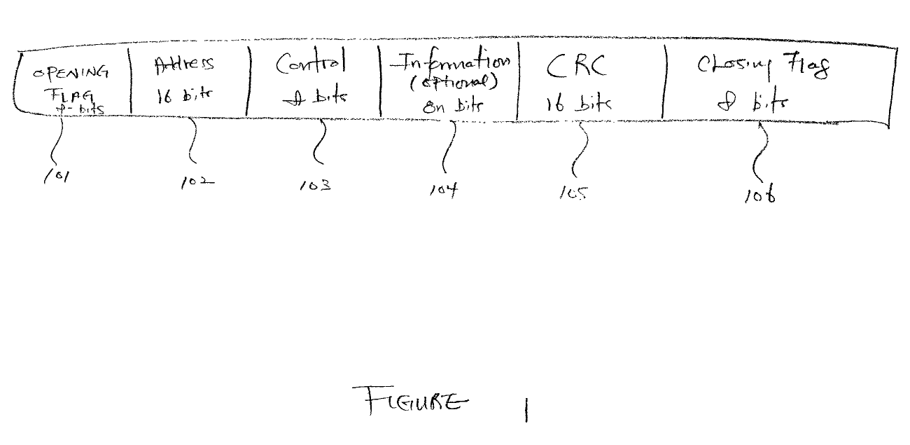

FIG. 2 illustrates a typical HDLC multimaster LAN configuration.

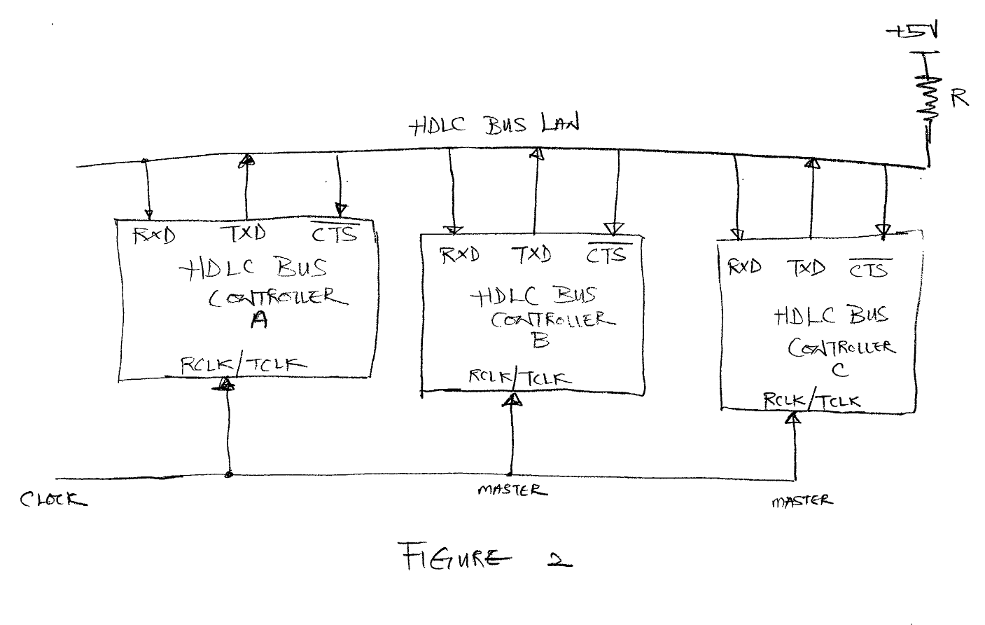

FIG. 3 illustrates a typical HDLC bus single-master configuration.

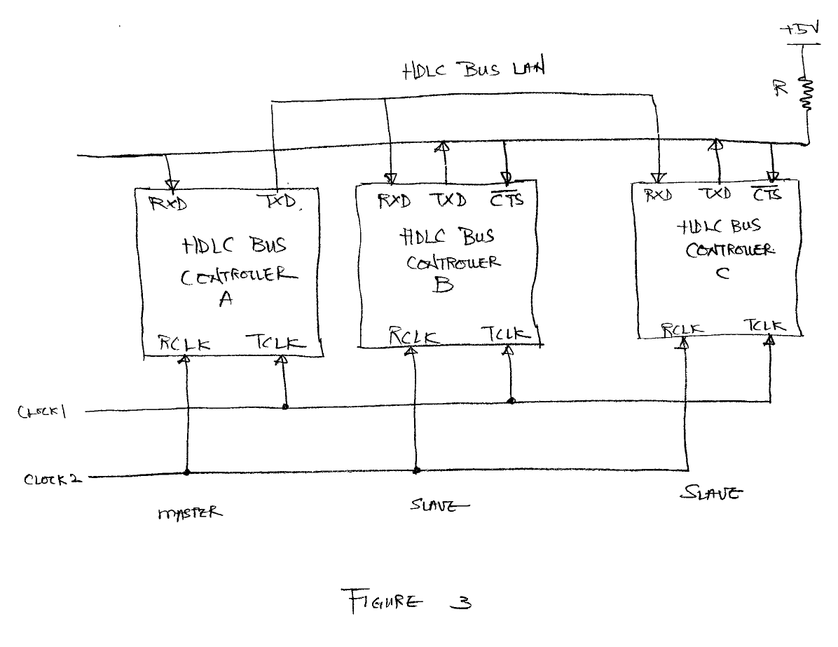

FIG. 4 illustrates a typical timing chart for detecting an HDLC bus collision.

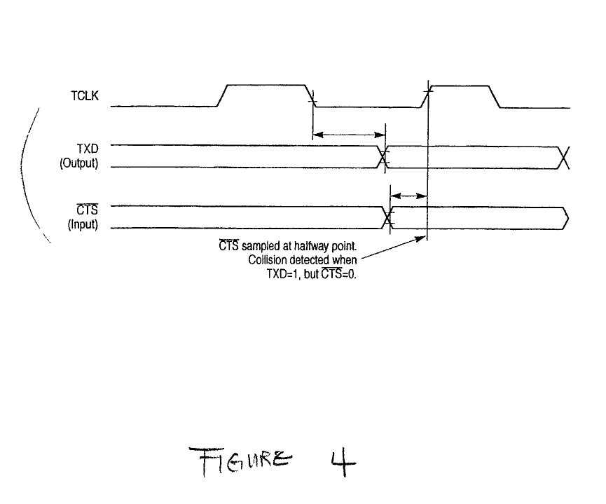

FIG. 5A illustrates a block diagram of a serial control bus interface with an HDLC bus in a radially distributed point-to-point architecture with fault isolation in accordance with one embodiment of the present invention.

FIG. 5B illustrates a block diagram of a serial control bus interface with an HDLC bus in a radially distributed point-to-point architecture with fault isolation with multiple peripheral cards and a redundant system controller in an optical networking system in accordance with one embodiment of the present invention.

FIG. 6 illustrates a full duplex serial control bus interface with an HDLC bus in a radially distributed point-to-point architecture with fault isolation in accordance with one embodiment of the present invention.

FIG. 7 illustrates a half duplex serial control bus interface with an HDLC bus in a radially distributed point-to-point architecture with fault isolation in accordance with one embodiment of the present invention.

FIG. 8 illustrates a timing diagram of the serial control bus interface of FIG. 5 in accordance with one embodiment of the present invention.

FIG. 9 illustrates a flow chart for powering on a peripheral card and establishing serial control bus (SCB) communication between the peripheral card and the system controller as part of an initial turn-up procedure for the peripheral card in accordance with one embodiment of the present invention.

FIG. 10 illustrates a flow chart for a peripheral card SCB communication fault handling procedure in accordance with one embodiment of the present invention.

### DETAILED DESCRIPTION OF THE EMBODIMENTS

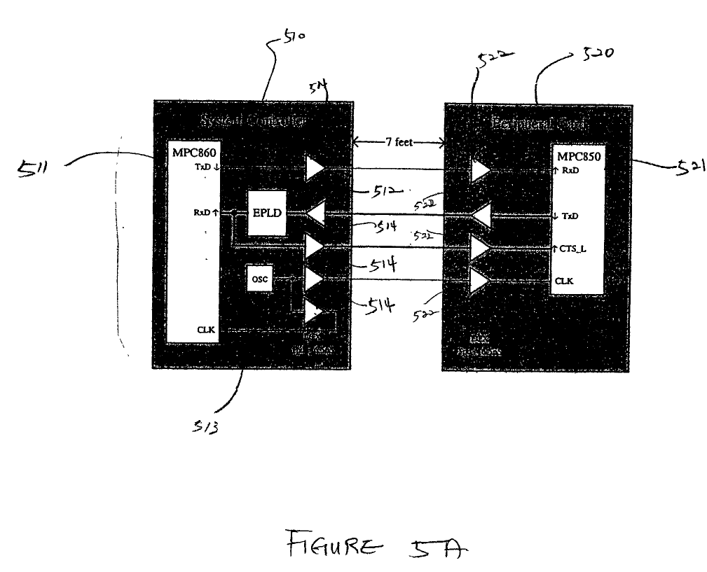

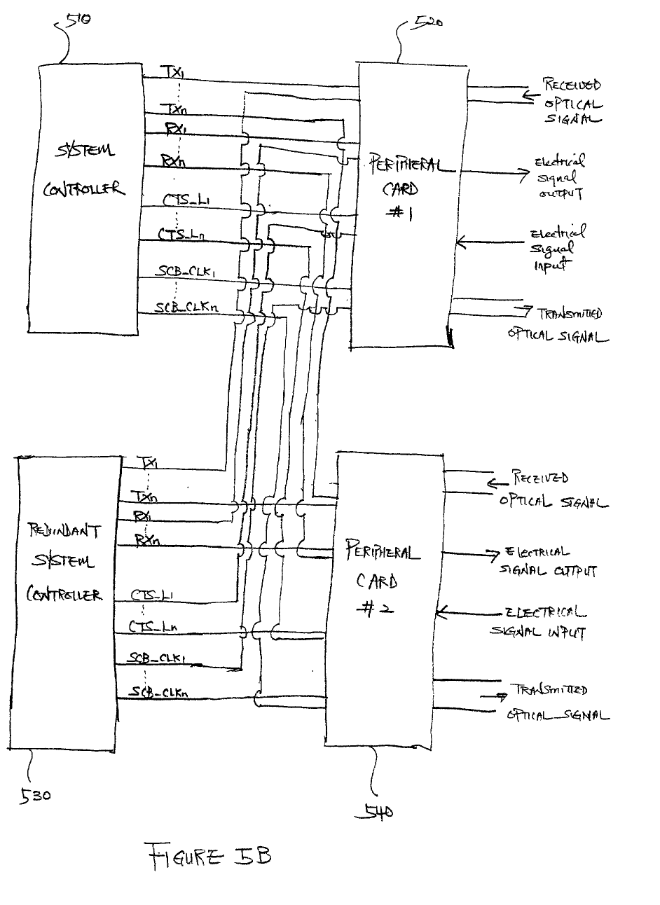

FIG. 5A illustrates a block diagram of a serial control bus interface with an HDLC bus in a radially distributed point-to-point architecture with fault isolation capabilities in accordance with one embodiment of the present invention. Referring to FIG. 5A, system controller 510 and a peripheral card 520 is separated by a distance range from a few inches to approximately seven feet. System controller 510 is provided with integrated communications microprocessor 511 such as MPC860 available from Motorola, Inc. As shown, data is transmitted on the falling edge and received on the rising edge of the clock. Also provided in system controller 510 is programmable logic device (PLD) 512, clock 513 and a plurality of buffers 514, while peripheral card 520 is provided with a similar microprocessor 521 and a plurality buffers 522.

Peripheral card 520 may be a generic, non-specific card which include a Transmit (TxD), Receive (RxD), and Clear to Send (CTS_L), and Bit Clock (CLK). These are made common at ech system controller 510 using PLD logic 512 and are buffered using buffers 514 such that each peripheral card has its own dedicated set of signals. Referring again to FIG. 5A, while only a single peripheral card 520 is shown, in one embodiment, several peripheral cards may be connected to system controller 510, with each peripheral card provided with its own hard wire connections to system controller 510.

In one embodiment, using a balanced duty cycle clock 513, the serial control bus may be configured to operate at approximately 3 MHz. That is, using a clock duty cycle of 50/50 and given a 10% margin of error, the maximum operating frequency of the HDLC bus is approximately 3 MHz. Using an un-balanced duty cycle clock, the maximum operating frequency of the HDLC bus shown in FIG. 5 may be approximately 6 MHz. In other words, using the CPU clock running at 49.152 MHz and a 1 cycle high 7 cycle low clock, the resulting clock is 20.3 nseconds high and 142.4 nseconds low. This meets the 115.7 nsecond requirement with a margin of 23%, and results in maximum operating frequency of the HDLC bus at approximately 6 MHz.

FIG. 5B illustrates a block diagram of a serial control bus interface with an HDLC bus in a radially distributed point-to-point architecture with fault isolation with multiple peripheral cards and a redundant system controller in an optical networking system in accordance with one embodiment of the present invention. Compared to the architecture shown in FIG. 5A, in addition to system controller 510 and peripheral card 520, the system of FIG. 5B includes redundant system controller 530 and a second peripheral card 540. Moreover, as can be seen from Figure SB, each peripheral cards 520, 540 are coupled to an optical network and thus, configured to receive and transmit optical signals such as OC-3, and are provided with electrical signal input and output for electrical signals such as STS-3. Additionally, while OC-3 and STS-3 are described herein as the optical and electrical signals, respectively, for the optical network, the serial control bus architecture for radially distributed point-to-point architecture with fault isolation capabilities of the present invention may be configured to support other optical signals such as OC-12, and OC-48, and their electrical counterparts STS-12, and STS-48.

It should be noted that the optical signals such as OC-3, OC-12, and OC-48 signals and their electrical counterparts STS-3, STS-12, and STS-48, respectively, are supported by data paths separate from the serial control bus. Furthermore, the serial control bus is generally to control and monitor the hardware (for example, the peripheral cards connected to the system controller) that support these optical signals and their electrical counterparts.

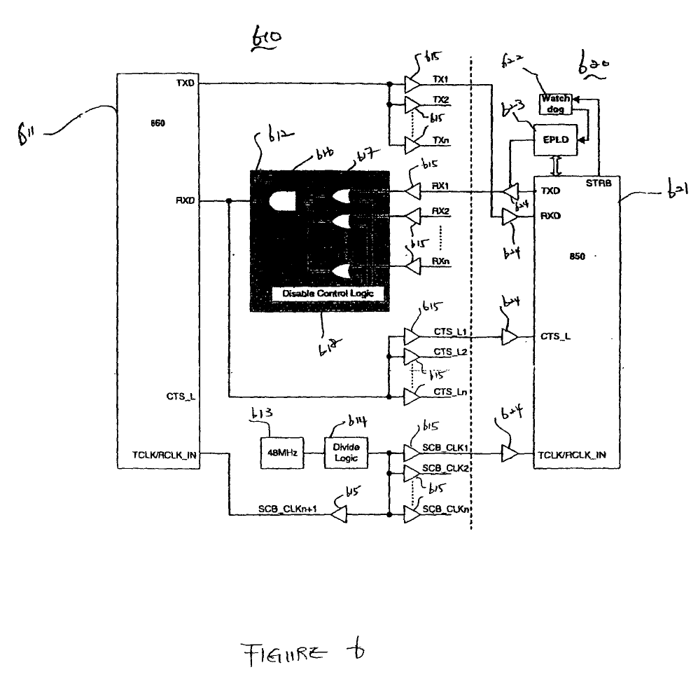

FIG. 6 illustrates a full duplex serial control bus interface with an HDLC bus in a radially distributed point-to-point architecture with fault isolation in accordance with one embodiment of the present invention. Referring to FIG. 6, on the system controller side 610, there is provided microprocessor 611, programmable logic device (PLD) 612, clock 513, divide logic 614 and a plurality of buffers 615. PLD 612 can include, for example, AND gate 616, several OR gates 617, and disable control logic 618. Also shown in FIG. 6 is peripheral card 620 which includes microprocessor 621, watchdog timer 622, EPLD 623, and a plurality of buffers 624. Separate buffers 624 are provided for each peripheral card 620 such that separate hard wired connection is provided between each peripheral card 620 and system controller 610.

In one embodiment, EPLD 623 may be configured to receive the time out signal from watchdog timer 622 and use the time out signal to automatically disable the TXD output of microprocessor 621 of peripheral card 620 in the event that microprocessor 621 hangs. This immediately turns over the TXD output of peripheral card 620 from the “bussed” TXD signal set within a few hundred milliseconds. In this manner, a fail safe may be provided that will limit the amount of time that peripheral card 620 may potentially take down the bussed serial control bus interface.

In operation, TXD terminal is connected to the CTS_L terminal of peripheral card 620 which is used to detect activity on the bus. If no activity (i.e., a series of “1”s) is detected on CTS_L terminal, then peripheral card 620 gains mastership of the bus and is allowed to transmit. On the other hand, if activity is detected (i.e., a series of “0”s), then peripheral card 620 is held off. Moreover, if two peripheral cards begin to transmit simultaneously, the first peripheral card to detect a “0” on its CTS_L terminal when a “1” was expected backs off and prepares to retransmit at the next opportunity.

Moreover, the Bit Clock is common to all peripheral cards. It may be generated on the primary and redundant system controllers (on architecture that includes a redundant system controller in addition to the primary system controller, for example, as shown in FIG. 5B) using 48 MHz clock source 613. The 48 MHz clock signal from clock 613 is divided down using divide logic 614 to 6 MHz (1 cycle high, 7 cycles low) to generate the Bit Clock SCB_CLKn. Additionally, a disable control for the TXD signals may be provided which includes a watchdog timer 622 external to the CPU and a bit in Common Control Register 1 of EPLD 623. After booting, the CPU must enable the TXD signals by setting a bit in Common Control Register 1. If the CPU should hang, the watchdog timer 622 will time out and latch the TXD control to the disabled state. The CPU must recover from its hung state and write Common Control Register 1 again in order to re-enable the TXD signals. The reset from the primary and redundant system controllers also latches the TXD control to the disabled state.

In one embodiment, an optical frequency division multiplexing system (optical FDM) may be configured with two identical full duplex bussed HDLC protocol serial interfaces to provide communication between a primary system controller and peripheral cards, as well as a redundant system controller and the peripheral cards. Further detailed information related to optical FDM may be found in pending U.S. patent application Ser. No. 09/405,367 entitled “Optical Communications Networks Utilizing Frequency Division Multiplexing” filed Sep. 24, 1999, and PCT application no. PCT/US00/00921 of the same title filed on Jan. 13, 2000, the disclosures of each of which are incorporated herein in their entirety by reference for all purposes.

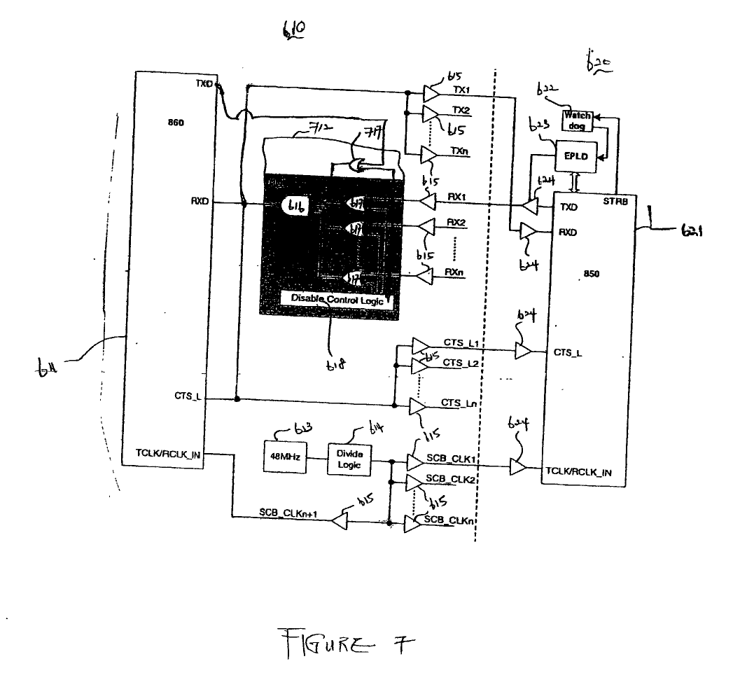

FIG. 7 illustrates a half duplex serial control bus interface with an HDLC bus in a radially distributed point-to-point architecture with fault isolation in accordance with one embodiment of the present invention. As can be seen, some modification to system controller is necessary to achieve half-duplex mode as compared with the full duplex mode shown in FIG. 6. In particular, PLD 712 is provided with an additional OR gate 717 which receives its inputs from TXD terminal of system controller 610 and disable control logic 618 of PLD 712, and provides it output to AND gate 616 to be ANDed with the outputs of the other OR gates 617 of PLD 712

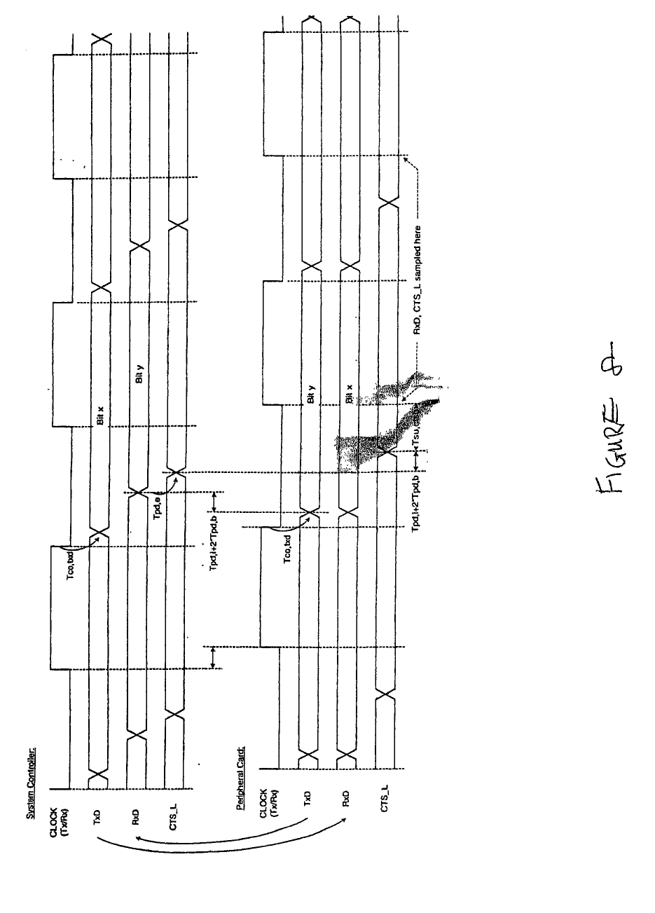

FIG. 8 illustrates a timing diagram of the serial control bus interface of FIG. 5A in accordance with one embodiment of the present invention. Referring to FIG. 8, for purposes of evaluating the timing, it is assumed that data is transmitted on the falling edge of the clock and received on the rising edge. Moreover, the duty cycle of the distributed bit clock is assumed to be 60/40, while the worst case path is the CTS_L loop from the farthest peripheral card indicated by the bold path in FIG. 5A. The CTS_L loop, or the turnaround time, is the time taken for the CTS_L signal to travel from the peripheral card to the system controller and back.

In one embodiment, this CTS_L turnaround time was determined to be 115.7 nseconds with no margin, which, in turn, translates to the minimum low time of the clock. As discussed above with reference to Figure SA, a timing evaluation using a CPU clock operating at 49.152 MHz with a 1 cycle high 7 cycle low clock (i.e., unbalanced duty cycle) results in the minimum low time of the clock at 142.4 nseconds and 20.3 nseconds high, allowing operation of the bus to be operated at approximately 6 MHz.

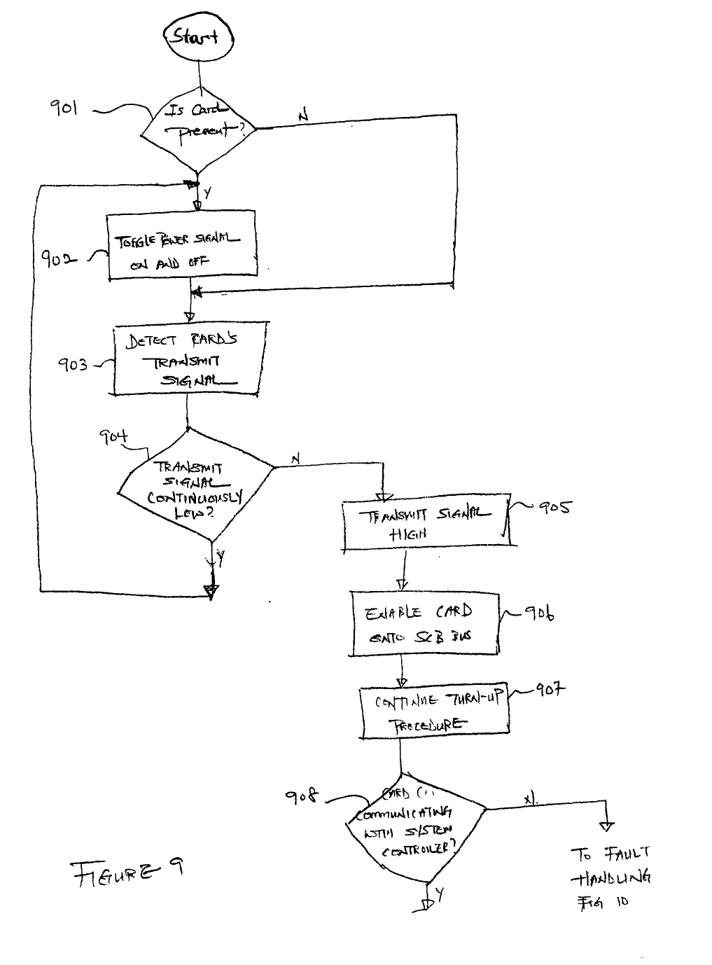

FIG. 9 illustrates a flow chart for powering on a peripheral card and establishing serial control bus (SCB) communication between the peripheral cards and the system controller as part of an initial turn-up procedure for the peripheral card in accordance with one embodiment of the present invention. As shown, at step 961, it is determined whether a peripheral card presence indication is detected. If the peripheral card present indication is detected at step 901, then it is determined that the peripheral card can be powered on immediately and proceeds to the power on procedure of steps 902-906. Otherwise, if the system controller has been installed in a running system, peripheral card power on check procedure is implemented at steps 903 to 905.

In particular, at step 902, to power on the peripheral card, the system controller turns the POWER signal on briefly and off. Thereafter, the system controller performs power on check procedure at steps 903 to 905 to verify that the peripheral card's power supply is functioning properly. It should be noted here that the POWER signal can be used to power on a peripheral card and to reset all hardware on that peripheral card.

As set forth above, the system controller uses this POWER signal to power on a peripheral card by toggling the POWER signal on briefly and then off again. While the POWER signal is on, the peripheral card's processor and other hardware on the card are reset. When the POWER signal is turned off, the processor is allowed to run and other peripheral card hardware is released from reset. Once a peripheral card is powered on, the system controller cannot power that peripheral card off again. If the system controller turns on the POWER signal for a particular peripheral card that is already on, it will reset the processor and all other peripheral card hardware, but will not affect the peripheral card's power. The system controller may hold a peripheral card's processor and other hardware in a reset state by holding the POWER signal on. It should be noted that the POWER signal is used to power on peripheral cards and to hold the peripheral cards in a reset state if communication with a peripheral card's processor cannot be established.

Additionally, a RESET signal is used to reset a peripheral card's processor without resetting other hardware on the particular peripheral card. This can be used to attempt to reestablish communication with a peripheral card when the processor is not communicating. Furthermore, if communication with a peripheral card's processor cannot be established, then a hard reset using the POWER signal is used.

Referring back to FIG. 9, after toggling the POWER signal on and off at step 902, or if it is determined at step 901 that the system controller has been installed in a running system, at step 903, the peripheral card's transmit signal is detected and at step 904, it is determined whether the transmit signal is continuously low or high. If it is determined at step 904 that the peripheral card's transmit signal is continuously low, that the procedure returns to step 902 to attempt to power on the peripheral card. Otherwise, it is determined at step 905 that the transmit signal of the peripheral card is high. It should be noted that if it is determined at step 901 that the system controller is installed in a running system, the system controller must first determine if the installed peripheral cards are already powered on to prevent taking down service by hard resetting the peripheral cards.

The state of the SCB transmit signal from all peripheral cards (i.e., the system controller's receive signal from each peripheral card) can be detected by the system controller. A peripheral card that is powered on will hold its transmit signal high unless it is transmitting. If the system controller detects that the peripheral card's transmit signal is high, then the system controller can safely enable the peripheral card on the system controller's internal SCB bus without disrupting traffic. On the other hand, if the peripheral card's transmit signal is continuously low, either the peripheral card has not been turned on, or the peripheral card's power supply is faulty.

Referring again to FIG. 9, if it is determined that the transmit signal of the peripheral card is high at step 905, then the system controller enables the peripheral card onto the SCB bus at step 906, and communication between the system controller and the peripheral card may begin. The system controller must not enable a peripheral card onto the SCB bus unless it has verified that the peripheral card is powered on. If a peripheral card that is not powered on or has power supply failure is enabled on the SCB bus, the peripheral card will short the bus to ground preventing communication with all peripheral cards in the system.

Thereafter, at step 907, the system controller continues with the turn-up procedure by retrieving manufacturing information from the peripheral card, downloading the peripheral card's software, and configuring the peripheral card as necessary. It should be noted here that when a peripheral card presence signal is detected from an installed peripheral card or when the system controller is installed in a system that is already supporting data traffic, the system controller performs the peripheral card turn-up procedure. The turn-up procedure involves steps including power on, establishing SCB communication, downloading software, configuring the peripheral card and other turn-up steps based upon the peripheral card type. Moreover, in addition to the ability to check each individual peripheral card's transmit signal, the system controller may also verify the integrity of the SBC bus itself by sensing the combined SCB bus signal and determining that the signal is not continuously low. If the signal is bad, then it is determined that either one of the peripheral cards is shorting the signal or the system controller's receive circuitry is faulty.

During the initial communication with the peripheral card as described above, the system controller may determine that the peripheral card's processor is not communicating properly. More particularly, at step 908, the system controller determines whether the processor for the peripheral card is communicating. If so, then the peripheral card power on procedure ends. Otherwise, the peripheral card is subject to fault handling procedure as described below.

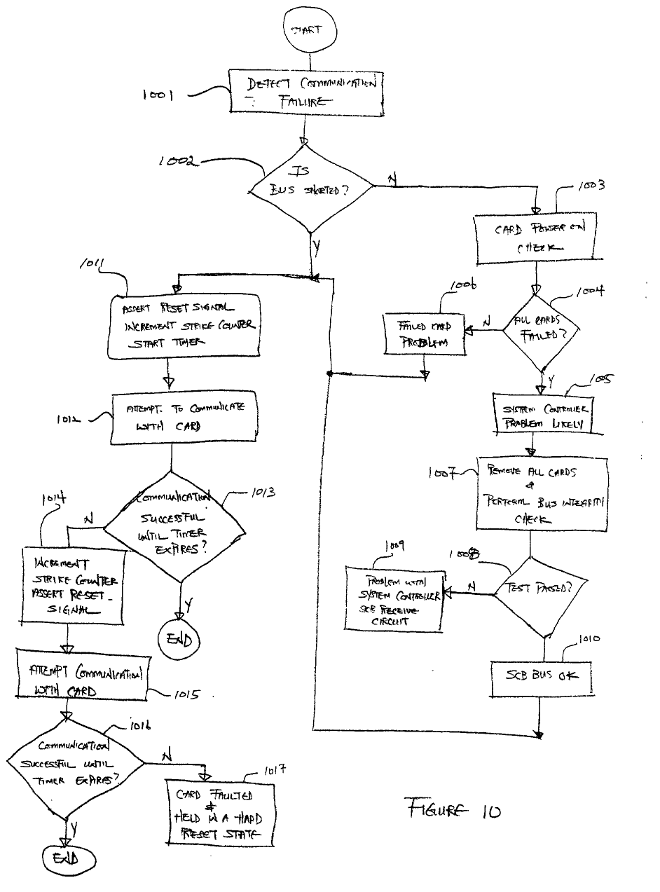

FIG. 10 illustrates a flow chart for a peripheral card SCB communication fault handling procedure in accordance with one embodiment of the present invention. Referring to FIG. 10, when the system controller detects that the communication path between the system controller and a peripheral card has failed, the system controller first invokes SCB fault isolation procedure as part of the peripheral card SCB communication fault handling procedure. The first indication of a communication failure is most likely indicated by the peripheral card's lack of response to a system controller request or background poll. Failures of this type may be caused by the peripheral card, the system controller, or the SCB bus itself. Since the SCB bus failure is the most critical of the three causes of failure and will almost certainly cause other peripheral card communications to fail, this is checked first.

In particular, as shown, at step 1001, a communication failure between the system controller and the peripheral card is first detected. Then, at step 1002, it is determined whether the SCB bus is shorted by performing SCB Bus integrity check which, as mentioned above, involves the system controller sensing the combined SCB bus signal and verifying that the transmit signal of the peripheral card is not continuously low. If at step 1002 it is determined that the SCB bus is not shorted (i.e., the transmit signal of the peripheral card is continuously held low), then it can be determined that either one of the peripheral cards is shorting the signal or the system controller's receive circuit is faulty.

To isolate the SCB bus failure to a particular peripheral card, the system controller performs peripheral card power on check procedure on each of the individual peripheral cards at step 1003. It should be noted that the peripheral card power on check procedure is similar to the power on check procedure of steps 903 to 905 shown in FIG. 9 performed by the system. If only one peripheral card fails the power on check procedure, it is determined at step 1006 that the particular failed peripheral card is the cause of the bus failure.

On the other hand, if it is determined at step 1004 that all peripheral cards failed the power on check procedure, it is determined at step 1005 that the bus failure is more likely due to the system controller itself. In this case, at step 1007, the system controller removes all of the peripheral cards from the SCB bus and performs the SCB bus integrity check again as discussed in conjunction with step 1002 the system controller detects the combined SCB bus signal and verifies that the transmit signal of the peripheral card is not continuously low. If it is determined that the transmit signal is continuously low, then at step 1009 that the bus failure is likely due to the system controller's SCB receive circuit. In this case, the system controller faults itself allowing a redundant system controller to take over, if available.

If the transmit signal of the peripheral card is determined to not be continuously low at step 1009, then it is determined at step 1010 that the SCB bus is not shorted and the system controller invokes peripheral card communication fault recovery procedure to be performed on the faulty peripheral card or cards as will be described below.

Referring again to FIG. 10, a three strikes peripheral card recovery process is shown. In particular, if it is determined that the SCB bus is not shorted, the system controller performs the peripheral card communication fault recovery procedure for all peripheral card faults detected by the SCB isolation procedure set forth above. If the peripheral card power on check procedure failed for a particular peripheral card, the system controller attempts to recover by powering on the peripheral card again and verifying that the peripheral card powers up properly. If the power on procedure fails, the peripheral card is faulted and held in a hard reset state (i.e., POWER signal held on). For peripheral card communication faults that do not result in a power on check failure, the system controller performs the three strikes peripheral card recovery process of steps 1011 to 1017.

In particular, the system controller maintains a strike counter and an initialization timer for each peripheral card, and when the initial failure is detected, the system controller at step 1011 asserts the RESET signal, increments the strike counter and starts the 5 minute initialization timer for the particular peripheral card. Thereafter, at step 1012, the system controller attempts to communicate with the peripheral card as part of the normal turn-up process discussed above. If at step 1013 it is determined that the peripheral card does not communicate, or loses communication again before the initialization timer expires, at step 1014, the strike counter for the particular peripheral card is incremented (strike two) and the RESET signal is asserted again.

At step 1015, the system controller attempts to communicate with the peripheral card again, and at step 1016, if it is determined that the peripheral does not communicate, or loses communication again before the 5 minute initialization timer expires, and after three attempts (three strikes) before the initialization time has expired, at step 1017, the peripheral card is faulted and held in a hard reset state with the POWER signal held on. It should be noted that the 5 minute initialization timer is reset whenever a peripheral card is pulled, and is restarted when a peripheral card is installed in the system. If a peripheral card turn-up process is successful, and the initialization time expires, any communication fault that occurs after that time is counted as a first strike and the initialization timer is started again.

In the manner described above, the three strikes peripheral card recovery procedure recovers peripheral cards through the processor RESET signal if possible, but hard resets peripheral cards that cannot be recovered. In particular, the procedure provides the peripheral card with three opportunities (strikes) to come up within a five minute period before a hard fault is declared. This approach provides a good chance of recovery of intermittent faults including software errors, but also allows the system controller to shut down faulty peripheral cards individually that could be affecting service.

As described above, in accordance with the present invention, a system controller may be configured to utilize a serial control bus for fault isolation. In particular, since a single faulty peripheral card may short the serial control bus to ground, preventing communications with all other peripheral cards, in one embodiment of the present invention, separate transmit and collision connections are provided to each peripheral card from the system controller, where these separate connections are configured to isolate individual boards during fault diagnostics. In this manner, fault isolation may be achieved by first disabling transmit and collision connections to all cards and then individually enabling each peripheral card to verify communications. In this manner, it is possible to determine which, if any of the peripheral cards are faulty.

Moreover, as described above, in accordance with the present invention, a serial control bus is distributed across radial leads from the system controller to each peripheral card. When the receive signal from each peripheral card passes through a driver that may be individually disabled before being bussed through an AND gate on the system controller, fault isolation may be accomplished by turning off these drivers, one at a time, to identify any peripheral cards that may be affecting serial control bus communications. In this manner, in accordance with the present invention, a full duplex data communication may be achieved, allowing simultaneous transmit and receive operations between the system controller and a single peripheral card. In other words, full duplex operation may be achieved by not allowing peripheral cards to communicate directly together without first forwarding data to the system controller.

Various other modifications and alterations in the structure and method of operation of this invention will be apparent to those skilled in the art without departing from the scope and spirit of the invention. Although the invention has been described about specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A radially distributed serial control bus architecture, comprising:
a controller;
a plurality of connections, each connection having a first end and a second end, each of said first end of said each connection coupled to said controller; and
a plurality of peripheral cards each peripheral card individually coupled to a second end of a respective dedicated one of said plurality of connections.

2. The architecture of claim 1 wherein each of said peripheral cards includes a transmit connection and a collision connection, and further, wherein each of said transmit and collision connections for said each peripheral cards are connected to a separate second end of said respective dedicated one of said plurality of connections.

3. The architecture of claim 1 wherein each of said peripheral cards includes a transmit lead and a collision lead, and each of said transmit lead and said collision lead are separately coupled to said second end of said respective dedicated one of said plurality of connections.

4. The architecture of claim 1 further including a logic device provided between each of said peripheral cards and said controller.

5. The architecture of claim 4 wherein said logic device includes a field programmable gate array device.

6. The architecture of claim 4 wherein said logic device includes a plurality of drivers each dedicated to receive signals from a particular one of said plurality of peripheral cards, wherein said controller is configured to individually disable one or more of said plurality of drivers.

7. The architecture of claim 4 wherein said logic device includes:
a control unit for generating a control signal;
a plurality of OR gates each configured to perform an OR operation to said control signal and a signal received from a respective peripheral card; and
an AND gate configured to perform an AND operation to outputs of said OR gates, and to provide an output AND signal to said controller.

8. The architecture of claim 1 wherein each of said plurality of connections is a hard wire connection.

9. The architecture of claim 1 wherein said controller is one of a MPC 860 processor, a MPC 850 processor, and a MPC 8260 processor.

10. The architecture of claim 1 wherein said serial control bus is configured to operate at a frequency range between approximately 3 MHz and 6 MHz.

11. The architecture of claim 1 wherein each of said plurality of peripheral cards is separated from said system controller by a distance ranging from approximately one inch to seven feet.

12. The architecture of claim 1 wherein each of said plurality of peripheral cards are coupled to an optical data communications network, each configured to receive and transmit electrical and optical signals.

13. The architecture of claim 12 wherein said optical signals include one of OC-3, OC-12 and OC-48, and said electrical signals include one of STS-3, STS-12 and STS-48.

14. The architecture of claim 1 wherein said serial control bus may be configured to support a bandwidth of approximately 6 Mbps.

15. The architecture of claim 1 wherein said serial control bus may be configured to support half duplex mode and full duplex mode communication.

16. A method of providing a radially distributed serial control bus architecture, comprising the steps of:
connecting each of a first end of a plurality of connections to a controller; and
individually connecting each of a plurality of peripheral cards to a second end of a respective dedicated one of said plurality of connections.

17. The method of claim 16 wherein said step of individually connecting includes the step of separately connecting a transmit connection and a collision connection of each of said peripheral cards to said second end of said respective dedicated one of said plurality of connections.

18. The method of claim 16 wherein said step of individually connecting includes the step of individually coupling a transmit lead and a collision lead of each of said peripheral cards to said second end of said respective dedicated one of said plurality of connections.

19. The method of claim 16 further including the step of providing a logic device between each of said peripheral cards and said controller.

20. The method of claim 16 wherein said logic device includes a field programmable gate array device.

21. The method of claim 16 wherein said step of providing said logic device includes the steps of:
providing a plurality of drivers each dedicated to receive signals from a particular one of said plurality of peripheral cards; and
configuring said controller to individually disable one or more of said plurality of drivers.

22. The method of claim 21 wherein said step of providing said logic device includes the step of:
generating a control signal;
performing an OR operation to said control signal and a signal received from each peripheral card; and
performing an AND operation to outputs of said OR operations and generating an output AND signal.

23. The method of claim 16 wherein each of said plurality of connections is a hard wire connection.

24. The method of claim 16 wherein said controller is one of a MPC 860 processor, a MPC 850 processor, and a MPC 8260 processor.

25. The method of claim 16 wherein said serial control bus is configured to operate at a frequency range between approximately 3 MHz and 6 MHz.

26. The method of claim 16 wherein each of said plurality of connections is approximately one inch to seven feet in length.

27. The method of claim 16 further including the step of coupling each of said plurality of peripheral cards to an optical data communications network, and configuring said each peripheral card to receive and transmit electrical and optical signals.

28. The method of claim 27 wherein said optical signals include one of OC-3, OC-12 and OC-48, and said electrical signals include one of STS-3, STS-12 and STS-48.

29. The method of claim 16 wherein said serial control bus may be configured to support a bandwidth of approximately 6 Mbps.

30. The method of claim 16 wherein said serial control bus may be configured to support half duplex mode and full duplex mode communication.

31. A method of fault isolation in a serial control bus architecture, comprising the steps of:
detecting a signal communication failure on a data control bus;
performing a control bus integrity check; and
isolating the origin of said signal communication failure on said bus to a particular peripheral device.

32. The method of claim 31 wherein said communication failure includes a peripheral card lack of response to a system controller request or a background poll.

33. The method of claim 31 wherein said step of performing said bus integrity check includes the steps of:
detecting a combined control bus signal; and
determining whether a transmit signal from a peripheral device is continuously low.
